(19) United States
(12) Patent Application Publication
(10) Pub. No.: US 2026/0249625 A1
(43) Pub. Date: Aug. 27, 2026

(54) PRINTING APPARATUS

(71) Applicant: SEIKO EPSON CORPORATION, Tokyo (JP)

(72) Inventor: Daichisehan IWAMA, MATSUMOTO-SHI (JP)

(21) Appl. No.: 19/549,364

(22) Filed: Feb. 25, 2026

(30) Foreign Application Priority Data
Feb. 26, 2025 (JP) 2025-028729

(51) Int. Cl. B41J 11/70; B41J 11/66

(52) U.S. Cl. CPC B41J 11/70; B41J 11/663

(57) ABSTRACT

A printing apparatus includes a transport portion that transports a medium, a printing portion that forms an image on the medium, a cutting portion that has a fixed blade and a movable blade which moves up/down with respect to the fixed blade to cut the medium and that cuts the medium on which the image is formed by the printing portion, a discharge guide surface that receives a cut piece of the medium, which is cut by the cutting portion, and a contact portion that is disposed downstream of the movable blade in a discharge direction of the medium and comes into contact with a surface of the medium on a side close to the fixed blade when the cutting portion cuts the medium.

The present application is based on, and claims priority from JP Application Serial Number 2025-028729, filed February 26, 2025, the disclosure of which is hereby incorporated by reference herein in its entirety.

### BACKGROUND

### 1. Technical Field

The present disclosure relates to a printing apparatus.

### 2. Related Art

A printing apparatus of JP-A-2010-201676 includes a stage surface that defines a lower surface of a paper discharge port, a protruding portion formed at the stage surface, and an inclined guide surface extending downward downstream in the paper discharge direction from a downstream end edge of the stage surface in a paper discharge direction. Accordingly, it is described that a posture of a cut piece of a medium is made unstable by the protruding portion, and the cut piece can easily fall along the inclined guide surface.

However, even when the posture of the cut piece is made unstable as in the case of JP-A-2010-201676, the cut piece is attached to the inclined guide surface by an electrostatic force, and the cut piece is stationary on the inclined guide surface, in some cases. For this reason, there is room for improving work efficiency for a user.

### SUMMARY

According to an aspect of the present disclosure, in order to solve the problem, there is provided a printing apparatus including a transport portion that transports a medium, a printing portion that forms an image on the medium, a cutting portion that has a fixed blade and a movable blade which moves up/down with respect to the fixed blade to cut the medium and that cuts the medium on which the image is formed by the printing portion, a discharge guide surface that receives a cut piece of the medium, which is cut by the cutting portion, and a contact portion that is disposed downstream of the movable blade in a discharge direction of the medium and comes into contact with a surface of the medium on a side close to the fixed blade when the cutting portion cuts the medium.

### BRIEF DESCRIPTION OF THE DRAWINGS

FIG. 1 is a perspective view of a printing apparatus according to a first embodiment.

FIG. 2 is a perspective view of a roll body used in the printing apparatus.

FIG. 3 is an explanatory view showing a schematic configuration inside the printing apparatus.

FIG. 4 is a perspective view of a discharge guide member.

FIG. 5 is a schematic view showing a positional relationship between the discharge guide member and a cutting portion.

FIG. 6 is a block diagram showing a main portion configuration of a control system of the printing apparatus.

FIG. 7 is an explanatory view showing movement of a medium cut by the cutting portion.

FIG. 8 is a perspective view of a discharge guide member according to a second embodiment.

FIG. 9 is a diagram showing a configuration of a control system of a printing apparatus according to the second embodiment.

### DESCRIPTION OF EMBODIMENTS

### First Embodiment

Hereinafter, a printing apparatus 1 according to a first embodiment will be described. In the description, description of directions such as the front/rear, the left/right, and the up/down is the same as directions with respect to the printing apparatus 1 unless otherwise specified. In addition, a reference sign Y shown in each drawing indicates a forward direction of the printing apparatus 1, a reference sign X indicates a leftward direction of the printing apparatus 1, and a reference sign Z indicates an upward direction of the printing apparatus 1.

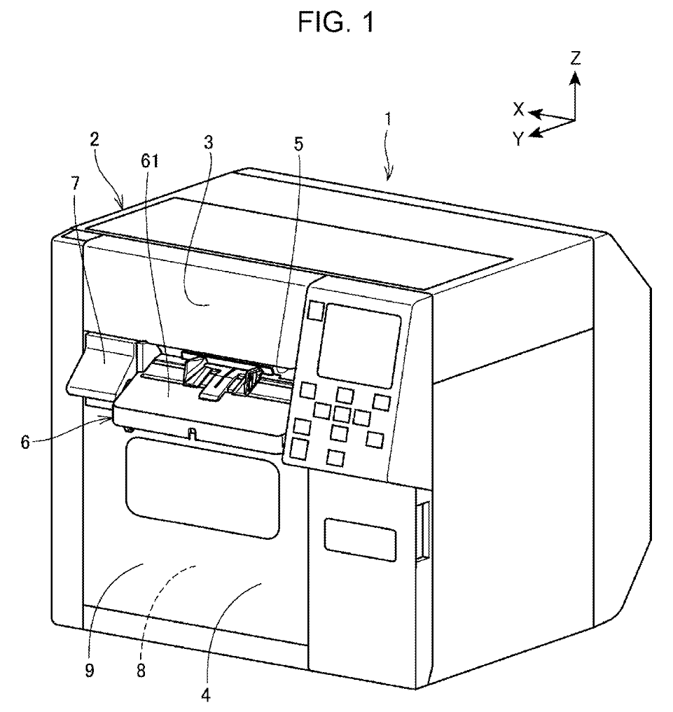

FIG. 1 is a perspective view of the printing apparatus 1 according to the first embodiment. As shown in FIG. 1, the printing apparatus 1 includes a printing apparatus main body 2 having a substantially rectangular parallelepiped shape as a whole. The front surface of the printing apparatus main body 2 is covered with an upper case 3 and a lower case 4. A discharge port Bis formed between the upper case 3 and the lower case 4. A discharge guide member 6 is provided below the discharge port 5. An opening/closing lever 7 is disposed on the side of the discharge guide member 6.

An opening portion of a roll body accommodating portion 8 is formed below the discharge guide member 6 and the opening/closing lever 7 in the lower case 4. The roll body accommodating portion 8 is formed inside the printing apparatus main body 2. The opening portion of the roll body accommodating portion 8 is blocked by an opening/closing cover 9. The opening/closing cover 9 is opened by operating the opening/closing lever 7. By setting the opening/closing cover 9 to an open state, a roll body 10 can be loaded into the roll body accommodating portion 8 via the opening portion of the roll body accommodating portion 8.

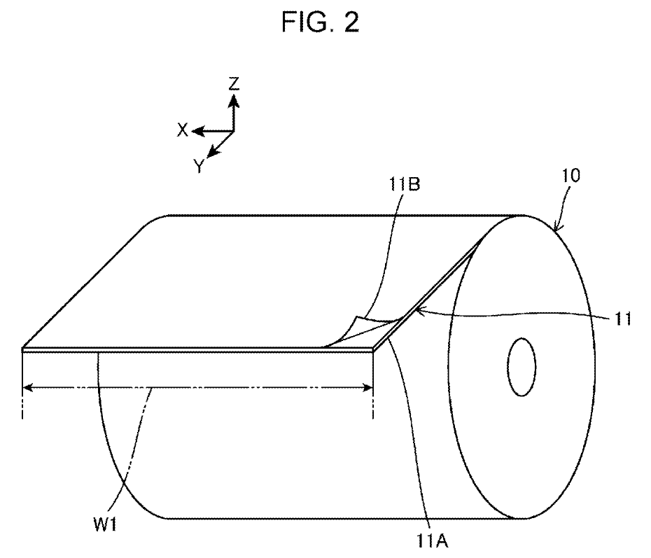

FIG. 2 is a perspective view of the roll body 10 used in the printing apparatus 1. The roll body 10 is obtained by winding a long band-shaped medium 11 into a roll shape. Hereinafter, a lateral direction of the band-shaped medium 11 will be referred to as a width direction. The medium 11 has a constant width dimension W1, which is a dimension in the width direction. In the present embodiment, the medium 11 is label paper in which a long full-surface label 11B having a constant width is attached to a surface of long peeling base paper 11A having a constant width. As the medium 11, long recording paper having a constant width, a label paper in which die-cut labels having a predetermined shape are attached at a constant interval to the long peeling base paper 11A having a constant width, or the like may be used. In addition, the medium 11 is not limited to a medium constituting the roll body 10. For example, the printing apparatus 1 may use the fanfold paper-shaped medium 11 folded in a fan shape.

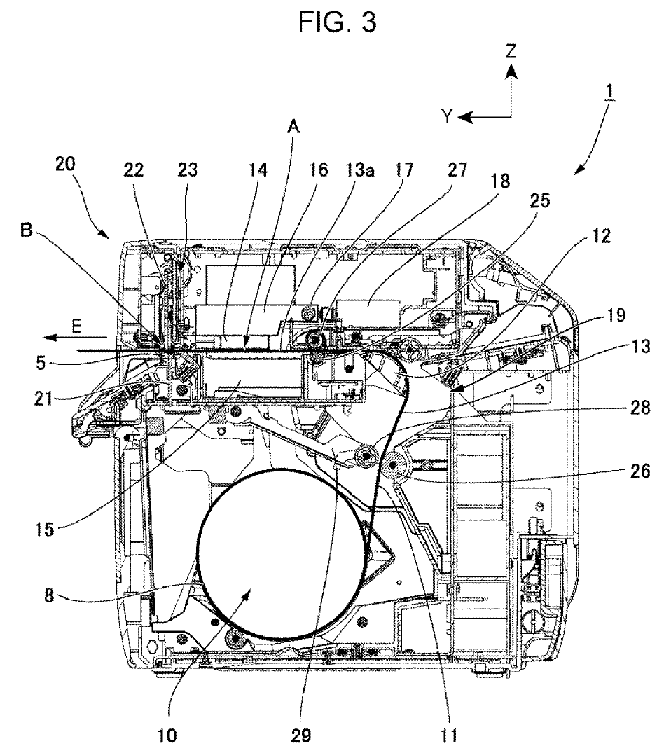

FIG. 3 is an explanatory view showing a schematic configuration inside the printing apparatus 1. As shown in FIG. 3, the roll body accommodating portion 8 is provided inside the printing apparatus 1. The roll body 10 is accommodated in a posture, in which the width direction of the medium 11 matches a left/right direction of the printing apparatus 1, in the roll body accommodating portion 8. The medium 11 is pulled out from the roll body 10 accommodated in the roll body accommodating portion 8 to the discharge port 5 formed in the front surface of the printing apparatus main body 2. In addition, the medium 11 is discharged forward via the discharge port 5. Hereinafter, a passage through which the medium 11 passes from the roll body 10 to the discharge port 5 will be referred to as a transport passage 13. In addition, a direction in which the medium 11 is discharged from the discharge port 5 will be referred to as a discharge direction E. Since the discharge direction E is along a longitudinal direction of the medium 11, the discharge direction E is a direction intersecting the width direction of the medium 11, that is, the left/right direction. More specifically, the width direction of the medium 11 and the discharge direction E are orthogonal to each other. In the present embodiment, the discharge direction E is the forward direction.

The medium 11 is pulled out from the roll body 10 obliquely upward and rearward and is wound around a curved tension guide 12. The tension guide 12 is biased upward by a spring, and a predetermined tension is applied to the medium 11 wound around the tension guide 12. The medium 11 wound around the tension guide 12 is curved forward along the tension guide 12 and is pulled out forward to the discharge port 5. Between the tension guide 12 and the discharge port 5, the medium 11 extends substantially horizontally between a printing head 14 and a suction platen 15. In the transport passage 13, a horizontal portion between the tension guide 12 and the discharge port 5 will be referred to as a horizontal portion 13a. The medium 11 that is transported through the horizontal portion 13a is set to have a direction in which the full-surface label 11B faces upward and the peeling base paper 11A faces downward.

The printing head 14 is disposed above the horizontal portion 13a. The printing head 14 is a device that jets ink to the full-surface label 11B of the medium 11 to form an image. The printing head 14 is mounted on a carriage 16. The carriage 16 reciprocates in the left/right direction along a carriage guide shaft 17 extending in the left/right direction through driving a carriage motor 18. The printing head Bcorresponds to an example of a "printing portion".

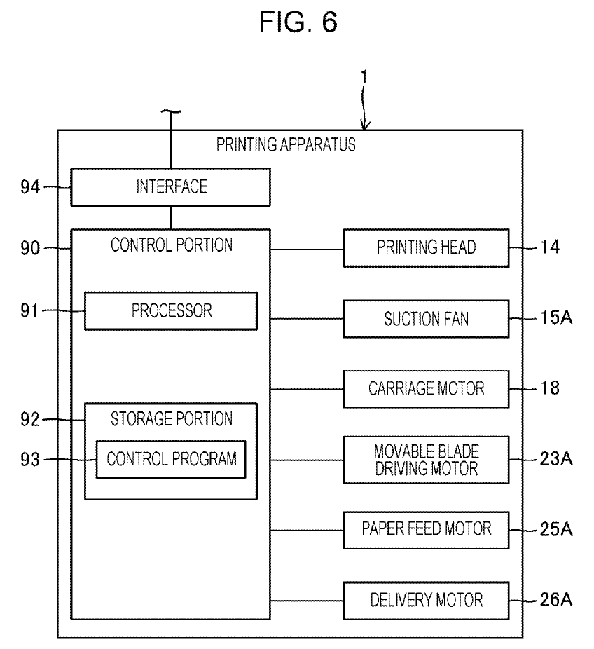

The suction platen 15 is disposed at a predetermined interval from the printing head 14 in an up/down direction. The suction platen 15 is positioned below the horizontal portion 13a. The suction platen 15 has a substantially horizontal plate shape and supports the medium 11 of the horizontal portion 13a. In addition, the medium 11 of the horizontal portion 13a is sucked by the suction platen 15 through driving a suction fan 15A shown in FIG. 6.

A printing position A, which is a position where printing is performed on the medium 11, is defined by the printing head 14 and the suction platen 15. In addition, a position downstream of the printing position A in a transport direction of the medium 11, that is, a front side of the printing position A is set to a cut position B. The cut position B is a position where the medium on which printing is performed at the printing position A is cut. A cutting portion 20 is disposed at the cut position B. The cutting portion 20 cuts the medium 11 on which printing is performed at the printing position A along the width direction of the medium 11.

The cutting portion 20 has a fixed blade 21 that does not move with respect to the printing apparatus main body 2 and a movable blade 22 that moves in the up/down direction with respect to the fixed blade 21. Each of the fixed blade 21 and the movable blade 22 is a blade having a cutting edge extending along the left/right direction, which is the width direction of the medium 11. In the present embodiment, the fixed blade 21 is disposed with the cutting edge facing upward, and the movable blade 22 is disposed with the cutting edge facing downward. In other words, the cutting edge is formed at a tip of the fixed blade 21 on an upper side, and the cutting edge is formed at a tip of the movable blade 22 on a lower side. In the cutting portion 20, the movable blade 22 is positioned on the front side of the fixed blade 21. That is, in the discharge direction E of the medium 11, the movable blade 22 is positioned downstream of the fixed blade 21. Furthermore, the discharge port 5 is positioned downstream of the movable blade 22 in the discharge direction E of the medium 11.

In addition, the cutting portion 20 is provided with a movable blade driving mechanism 23 that moves the movable blade 22 up/down with respect to the fixed blade 21. The movable blade driving mechanism 23 includes a movable blade driving motor 23A shown in FIG. 6. In addition, the movable blade driving mechanism 23 has, for example, a crank mechanism that converts an output of the movable blade driving motor 23A into a reciprocating motion along the up/down direction. When the cutting portion 20 cuts the medium 11, the movable blade 22 moves from the upper side to the lower side by the operation of the movable blade driving mechanism 23. The upper side corresponds to an example of "one side in the up/down direction". The lower side corresponds to an example of "another side in the up/down direction".

A transport portion 19 that transports the medium 11 along the transport passage 13 is provided inside the printing apparatus main body 2. The transport portion 19 has a paper feed roller 25. The paper feed roller 25 is a roller that comes into contact with the medium 11 from below the horizontal portion 13a. The paper feed roller 25 is rotated by driving a paper feed motor 25A shown in FIG. 6 and feeds the medium 11 of the horizontal portion 13a forward. In addition, the transport portion 19 has a first pressing roller 27 that is pressed from above toward the paper feed roller 25 with the medium 11 pinched therebetween. The first pressing roller 27 is a roller that rotates according to the medium 11 transported forward.

The transport portion 19 has a delivery roller 26. The delivery roller 26 comes into contact with the medium 11 upstream of the tension guide 12 in the transport passage 13. The delivery roller 26 is rotated by driving of a delivery motor 26A shown in FIG. 6 and delivers the medium 11 from the roll body accommodating portion 8. In addition, the transport portion 19 has a second pressing roller 28 that is pressed against the delivery roller 26 with the medium 11 pinched therebetween. The second pressing roller 28 is a roller that rotates according to the medium 11 transported along the transport passage 13. The second pressing roller 28 is provided at a tip portion of a pressing lever 29 extending from the lower side of the suction platen 15 rearward. The second pressing roller 28 is pressed against the delivery roller 26 by the pressing lever 29 being biased downward by a spring.

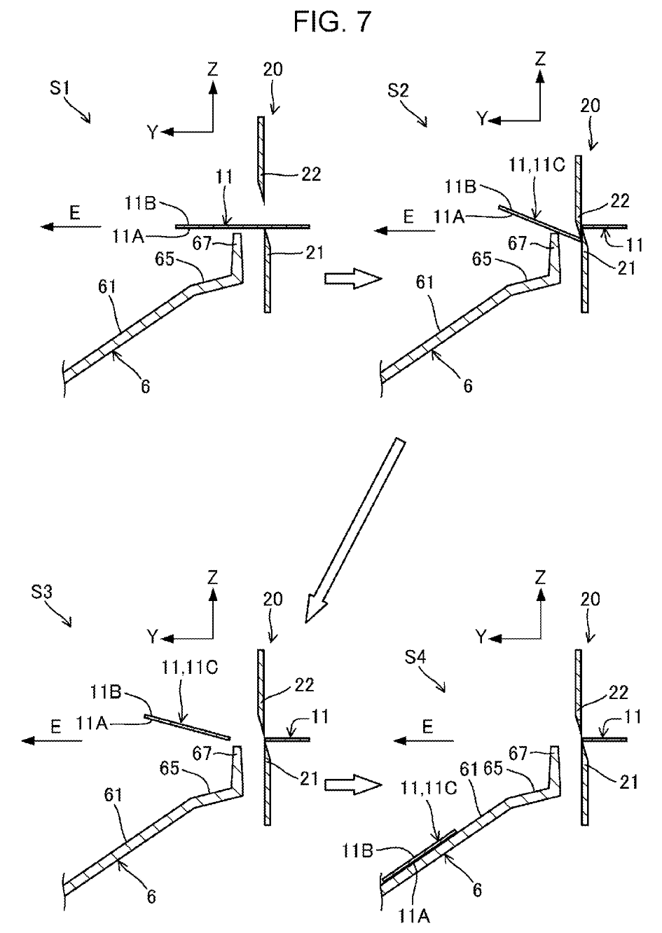

As described above, the medium 11 pulled out from the roll body 10 loaded in the roll body accommodating portion 8 is transported along the transport passage 13 by the transport portion 19. At the printing position A, the printing head 14 performs printing on the full-surface label 11B. At the cut position B, the medium 11 is cut by the cutting portion 20 to include a printing region at the printing position A. In addition, from the discharge port 5, a cut piece 11C having a desired cut length is issued as shown in FIG. 7 to be described later.

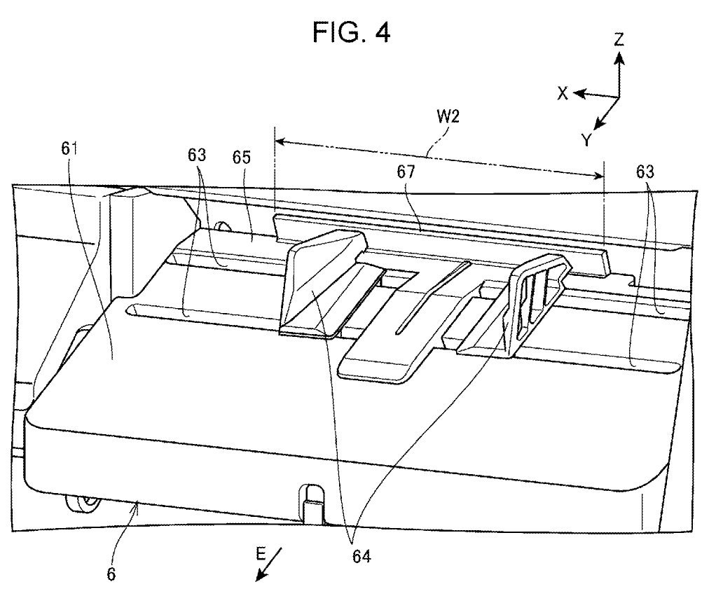

FIG. 4 is a perspective view of the discharge guide member 6. The discharge guide member 6 is a member that receives the cut piece 11C of the medium 11 cut by the cutting portion 20 after printing by the printing head 14. The discharge guide member 6 is provided below the discharge port 5.

The discharge guide member 6 has a discharge guide surface 61. The discharge guide surface 61 is a surface of the discharge guide member 6, which receives the cut piece 11C of the medium 11 shown in FIG. 7 to be described later. The discharge guide surface 61 faces upward. In addition, the discharge guide surface 61 is inclined in a direction in which the front side is positioned on the lower side. In other words, the discharge guide surface 61 is inclined in a direction in which a downstream portion in the discharge direction E is positioned on the lower side.

A guide groove 63 is formed in the discharge guide surface 61. The guide groove 63 is a groove extending in the left/right direction. The guide groove 63 is formed downward from the discharge guide surface 61 and penetrates the discharge guide member 6. In the present embodiment, two pairs of left/right guide grooves 63 are formed in the discharge guide surface 61 at an interval in a front/rear direction.

A pair of left/right width direction guides 64 are provided on the discharge guide surface 61. The width direction guides 64 are members that protrude above the discharge guide surface 61. The width direction guides 64 correct a shift of the medium 11 in the left/right direction by coming into contact with the medium 11 discharged from the discharge port 5 from an outside in the width direction. The width direction guides 64 are attached to the discharge guide surface 61 in a state where lower portions are inserted into the two guide grooves 63 arranged front/rear. When the width direction guides 64 receive a force in the left/right direction due to a user's operation or the like, the width direction guides 64 move in the left/right direction on the discharge guide surface 61 as the width direction guides 64 slide with respect to the pair of front/rear guide grooves 63. That is, the pair of left/right width direction guides 64 are movable.

The pair of left/right width direction guides 64 are coupled to each other by a linkage mechanism (not shown). The linkage mechanism is a mechanism that when one width direction guide 64 moves, moves the other width direction guide 64 by the same distance in a direction opposite to the one width direction guide 64. The linkage mechanism may be, for example, a mechanism having a pair of rack gears attached to the pair of width direction guides 64, respectively, a pinion gear rotatably attached to the discharge guide member 6 and meshes with the pair of rack gears, and the like.

The discharge guide member 6 is formed with an upper surface 65. The upper surface 65 is a surface facing upward. The inclination of the upper surface 65 with a horizontal plane as reference is smaller than the inclination of the discharge guide surface 61. The upper surface 65 is formed at the discharge guide member 6 on a rear side of the discharge guide surface 61. In other words, the upper surface 65 is formed upstream of the discharge guide surface 61 in the discharge direction E.

A contact portion 67 is formed in the discharge guide member 6. The contact portion 67 protrudes upward from the upper surface 65 in the discharge guide member 6. That is, the contact portion 67 is provided upstream of the discharge guide surface 61 and the width direction guides 64 in the discharge direction E. The contact portion 67 is formed with a longitudinal direction thereof as the left/right direction. A dimension W2 of the contact portion 67 in the left/right direction is larger than the width dimension W1 of the medium 11 having the maximum width dimension W1, among the media 11 corresponding to the printing apparatus 1.

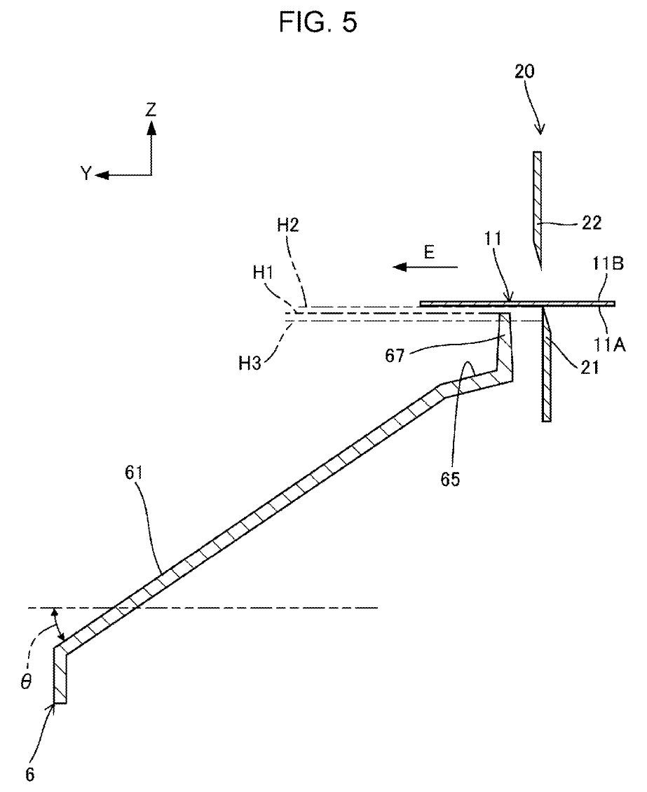

FIG. 5 is a schematic view showing a positional relationship between the discharge guide member 6 and the cutting portion 20. As shown in FIG. 5, the discharge guide surface 61 is inclined by an angle θ in a direction in which the downstream portion in the discharge direction E is positioned on the lower side with the horizontal plane as reference. The angle θ is an angle having a size of 30° or more and less than 90°.

In addition, as shown in FIG. 5, a position H1 of a tip of the contact portion 67 on the upper side in the up/down direction is positioned below a position H2 of the tip of the fixed blade 21 on the upper side in the up/down direction. In addition, the position H1 of the tip of the contact portion 67 on the upper side in the up/down direction is positioned above a position H3 of the tip of the movable blade 22 on the lower side in the up/down direction when the medium 11 is cut and moved to the lower side.

FIG. 6 is a block diagram showing a main portion configuration of a control system of the printing apparatus 1.

The printing apparatus 1 includes a control portion 90 that controls each portion of the printing apparatus 1. The control portion 90 includes a processor 91 that executes a control program 93 and a storage portion 92. The processor 91 is an arithmetic processing device configured with a CPU, a DSP, a microcomputer, and the like. In addition, the processor 91 may be configured with a plurality of pieces of hardware or may be configured with a single processor. In addition, the processor 91 may be hardware programmed to realize each function. That is, the processor 91 may be configured to install the control program 93 as a hardware circuit. In this case, for example, the processor 91 is configured with an ASIC or an FPGA. The processor 91 realizes various types of functions of the control portion 90 by executing the control program 93.

The CPU is an abbreviation of central processing unit. The DSP is an abbreviation of digital signal processor. The ASIC is an abbreviation of application specific integrated circuit. The FPGA is an abbreviation of field programmable gate array.

The storage portion 92 has a storage region that stores the control program 93 executed by the processor 91 and data processed by the processor 91. The storage portion 92 stores the control program 93 executed by the processor 91 and setting data including various types of set values related to an operation of the printing apparatus 1. The storage portion 92 has a non-volatile storage region that stores the control program 93 and data in a non-volatile manner. In addition, the storage portion 92 may include a volatile storage region and may constitute an area that temporarily stores the control program 93 executed by the processor 91 or data to be processed.

The interface 94 is electrically coupled to the control portion 90. The interface 94 is coupled to a device outside the printing apparatus 1. In the present embodiment, a host computer (not shown) is coupled to the interface 94. The host computer outputs data of an image to be printed by the printing apparatus 1 and the print data including a print instruction for the printing apparatus 1 to the printing apparatus 1 via the interface 94. The interface 94 may be, for example, a wired interface unit including a connector for coupling a cable and an interface circuit. In addition, the interface 94 may be a wireless communication interface that executes wireless data communication with the host computer.

In addition, the control portion 90 is electrically coupled to the printing head 14, the suction fan 15A, the carriage motor 18, the movable blade driving motor 23A, the paper feed motor 25A, and the delivery motor 26A. The suction fan 15A may be a blowing device of any type. The carriage motor 18, the movable blade driving motor 23A, the paper feed motor 25A, and the delivery motor 26A may be motors of any type.

Next, movement of the medium 11 cut by the cutting portion 20 will be described. FIG. 7 is an explanatory view showing the movement of the medium 11 cut by the cutting portion 20.

As shown in FIG. 7, in a state S1 before the medium 11 is cut, the movable blade 22 is in a state of being moved upward from the tip of the fixed blade 21 on the upper side. In the state S1, the medium 11 passes between the tip of the fixed blade 21 on the upper side and the tip of the movable blade 22 on the lower side and is transported to the front side of the movable blade 22.

Furthermore, in the state S1, a tip of the medium 11 on the front side is transported to the front side of the contact portion 67. As described above, the tip of the contact portion 67 on the upper side is positioned below the tip of the fixed blade 21 on the upper side. For this reason, the tip of the medium 11 on the front side is transported to the front side of the contact portion 67 without colliding with the contact portion 67.

After the state S1, in a state S2 when the medium 11 is cut, the movable blade 22 moves to the lower side through driving of the movable blade driving mechanism 23. Accordingly, the tip of the movable blade 22 on the lower side moves below the tip of the fixed blade 21 on the upper side. In addition, the medium 11 is cut by the fixed blade 21 and the movable blade 22, and the cut piece 11C is formed. The cut piece 11C is one positioned downstream in the discharge direction E, among the two pieces of the medium 11 cut by the fixed blade 21 and the movable blade 22.

As in the state S2, when the medium 11 is cut by the cutting portion 20, a rear end of the cut piece 11C is pressed from above to below by the movable blade 22. In addition, as described above, a front end of the medium 11 in the state S1 is positioned in front of the contact portion 67. Accordingly, a surface of the cut piece 11C on a peeling base paper 11A side comes into contact with the contact portion 67 from above. The surface of the cut piece 11C on the peeling base paper 11A side corresponds to an example of "a surface of a medium on a side close to a fixed blade".

As described above, in the present embodiment, the tip of the contact portion 67 on the upper side is positioned above the tip of the movable blade 22 on the lower side, which is moved to the lower side in the state S2. For this reason, the surface of the cut piece 11C on the peeling base paper 11A side easily comes into contact with the contact portion 67 from above.

As described above, in the state S2, the rear end of the cut piece 11C is pressed down by the movable blade 22 in a state of being supported by the contact portion 67 from below. Accordingly, a portion of the cut piece 11C mainly on the rear side of the contact portion 67 is deformed to bend.

As described above, in the present embodiment, the dimension W2 of the contact portion 67 in the left/right direction is larger than the maximum width dimension W1 of the medium 11 corresponding to the printing apparatus 1. For this reason, even when any medium 11 corresponding to the printing apparatus 1 is used, the entire cut piece 11C in the width direction easily comes into contact with the contact portion 67, and the cut piece 11C is easily deformed.

The cut piece 11C deformed in the state S2 is restored by elasticity and returns to a flat shape. At this time, a forward force is applied to the cut piece 11C as a reaction force against the deformation. For this reason, in a state S3 after the state S2, the cut piece 11C bounces forward.

In a state S4 after the state S3, the discharge guide surface 61 receives the cut piece 11C falling from above. As described above, since the cut piece 11C bounces forward in the state S3, the forward momentum easily remains in the cut piece 11C that falls on the discharge guide surface 61. For this reason, the cut piece 11C that falls on the discharge guide surface 61 easily slides forward on the discharge guide surface 61.

As described above, in the present embodiment, the discharge guide surface 61 is inclined by 30° or more in a direction in which the front side is positioned on the lower side with the horizontal plane as reference. For this reason, the cut piece 11C that falls on the discharge guide surface 61 easily slides forward on the discharge guide surface 61 due to the action of gravity and is unlikely to be stationary on the discharge guide surface 61.

After the state S4, the cut piece 11C that reaches a front end of the discharge guide surface 61 falls from the discharge guide surface 61 and is accommodated in a tray (not shown) or the like.

As described above, by making the cut piece 11C unlikely to remain on the discharge guide surface 61, occurrence of work of removing the cut piece 11C from the discharge guide surface 61 can be suppressed, and work efficiency for the user can be easily improved. In addition, since the cut pieces 11C are unlikely to overlap on the discharge guide surface 61 and friction between the cut pieces 11C can be suppressed, quality deterioration of the cut pieces 11C is easily suppressed.

### Second Embodiment

Next, a second embodiment of the present disclosure will be described.

Hereinafter, only points different from the first embodiment described above will be described, and redundant description or the like will be omitted. In addition, the first embodiment described above and the second embodiment can be combined in any manner to form a new embodiment.

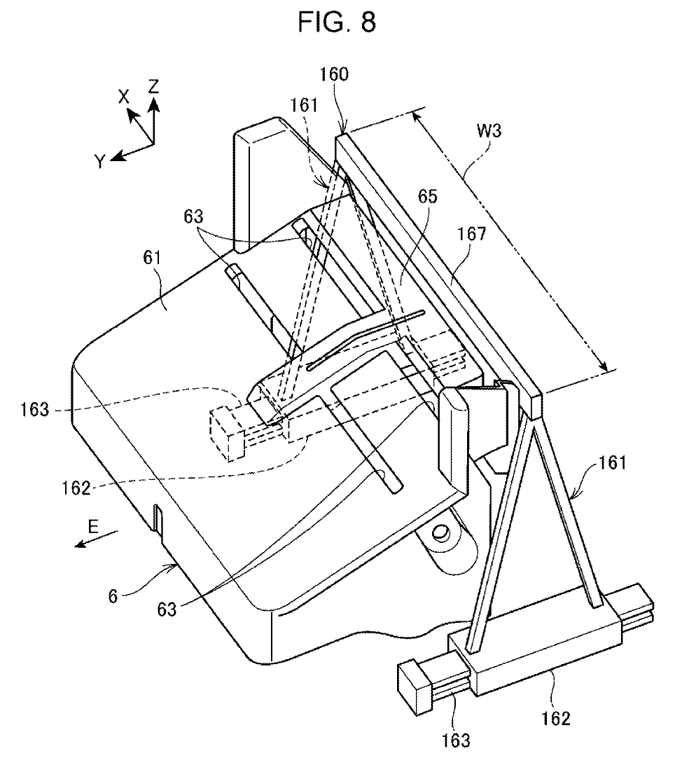

FIG. 8 is a perspective view of the discharge guide member 6 according to the second embodiment. In the second embodiment, the discharge guide member 6 is not formed with the contact portion 67 as in the first embodiment. In the second embodiment, a contact member 160 which is a member separate from the discharge guide member 6 is provided.

The contact member 160 has a contact portion 167. The contact portion 167 is formed in a rod shape extending in the left/right direction. The contact portion 167 comes into contact with a surface of the cut piece 11C on the peeling base paper 11A side when the medium 11 is cut by the cutting portion 20, in the same manner as the contact portion 67 of the first embodiment. The contact portion 167 has a dimension W3 in the left/right direction, which is equal to or larger than the maximum width dimension W1 of the medium 11 corresponding to the printing apparatus 1. Furthermore, a tip of the contact portion 167 on the upper side is provided at the same position as the tip of the contact portion 67 on the upper side of the first embodiment in the up/down direction.

The contact member 160 has a pair of left/right support portions 161. Both ends of the contact portion 167 in the left/right direction are supported by the pair of left/right support portions 161. The support portions 161 extend in the up/down direction and support the contact portion 167 with upper ends thereof. A moving portion 162 is provided at lower ends of the support portions 161. The moving portion 162 is attached to a rod-shaped member 163.

The rod-shaped member 163 is a member extending along the discharge direction E. In other words, the rod-shaped member 163 extends along the front/rear direction. The moving portion 162 of the support portions 161 is attached to be movable along the rod-shaped member 163 with respect to the rod-shaped member 163. That is, the support portions 161 are configured to be movable along the discharge direction E.

In the present embodiment, the moving portion 162 is a linear guide, and the rod-shaped member 163 is a rail. The moving portion 162 and the rod-shaped member 163 may be configured with other mechanical elements such as a linear bush and a linear shaft.

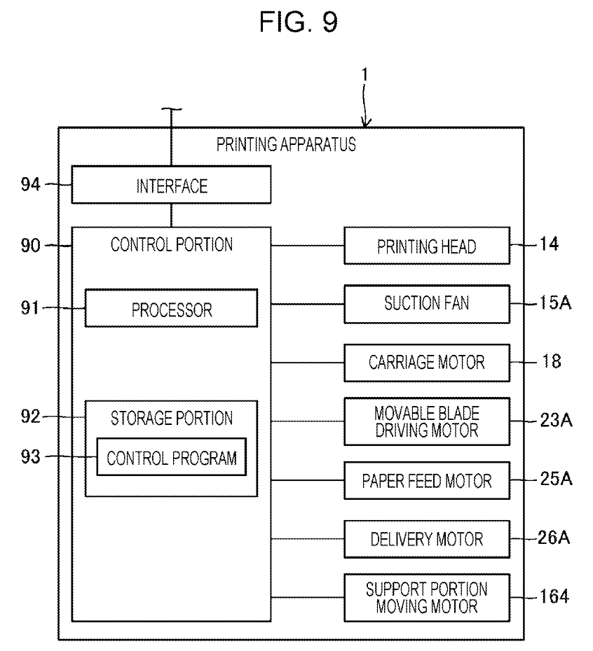

FIG. 9 is a diagram showing a configuration of the control system of the printing apparatus 1 according to the second embodiment. In the second embodiment, the printing apparatus 1 has a support portion moving motor 164. The support portion moving motor 164 is a motor that moves the pair of support portions 161 along the discharge direction E through driving. The support portion moving motor 164 may be, for example, a motor built in the moving portion 162. The support portion moving motor 164 is electrically coupled to the control portion 90 and is controlled by the control portion 90. The support portion moving motor 164 corresponds to an example of a "drive portion".

The processor 91 controls the support portion moving motor 164 and moves the positions of the pair of support portions 161 in a direction along the discharge direction E according to a cut length of the cut piece 11C cut from the medium 11. The cut length of the cut piece 11C is a length dimension of the cut piece 11C in a direction orthogonal to the width direction.

Specifically, the processor 91 reads the set value of the cut length of the cut piece 11C from print data received via the interface 94 or setting data stored in the storage portion 92. The processor 91 controls the support portion moving motor 164 according to the read set value of the cut length and moves the support portions 161 along the discharge direction E. In the present embodiment, the processor 91 moves the support portions 161 downstream in the discharge direction E when the cut length of the cut piece 11C is long, compared to when the cut length is short. Accordingly, when the cut length of the cut piece 11C is long and a frictional force generated between the cut piece 11C and the discharge guide surface 61 is large, deformation of the cut piece 11C can be increased, and a reaction force against the deformation can be increased. For this reason, a force applied to the cut piece 11C downstream in the discharge direction E can be increased, and stop of the cut piece 11C on the discharge guide surface 61 can be suppressed.

Each of the embodiments described above merely describes one specific example to which the present disclosure is applied. The present disclosure is not limited to the configuration of the embodiments and can be implemented in various aspects without departing from the gist of the disclosure.

For example, in the embodiments described above, in the cutting portion 20, the fixed blade 21 is disposed with the cutting edge facing the upper side, and the movable blade 22 is disposed with the cutting edge facing the lower side. However, without being limited thereto, a configuration where the fixed blade 21 is disposed with the cutting edge facing downward and the movable blade 22 is disposed with the cutting edge facing upward may be adopted. In this case, the movable blade 22 moves from the lower side toward the upper side of the fixed blade 21 when the medium 11 is cut. In addition, a tip of the contact portion 167 on the lower side comes into contact with the full-surface label 11B of the medium 11 from the upper side.

In addition, in this case, the contact portion 167 may be configured such that the tip on the lower side thereof is positioned above a tip of the fixed blade 21 on the lower side. Accordingly, the front end of the medium 11 is easily transported to the front side of the contact portion 167 without interfering with the contact portion 167.

In addition, in this case, the contact portion 167 may be configured such that the tip on the lower side thereof is positioned below the tip of the movable blade 22 on the upper side, which moves to the upper side when the medium 11 is cut. Accordingly, when the rear end of the cut piece 11C is pressed to the upper side by the movable blade 22, a surface of the cut piece 11C on a full-surface label 11B side more easily comes into contact with the contact portion 167 from below.

In the second embodiment described above, the contact portion 167 is supported by the upper ends of the support portions 161. However, without being limited thereto, for example, the support portions 161 may be configured such that the upper ends are attached to the printing apparatus main body 2 or the like, and the contact portion 167 is supported by the lower ends of the support portions 161. In addition, the support portions 161 may not be configured to be movable along the discharge direction E and may be fixed to the printing apparatus main body 2 or the like.

In the embodiments described above, a serial head type is exemplified as the printing head 14, but a line head type may be adopted without being limited thereto. In addition, a printing method of the printing head 14 is not limited to an ink jet method.

Directions such as horizontal and vertical, various types of numerical values, and shapes in the embodiments described above include so-called equivalent ranges that have the same effects and advantages as those of the directions, numerical values, and shapes unless otherwise specified.

### Summary of Present Disclosure

Hereinafter, summaries of the present disclosure will be added.

### Supplementary note 1

A printing apparatus including: a transport portion that transports a medium; a printing portion that forms an image on the medium; a cutting portion that has a fixed blade and a movable blade which moves up/down with respect to the fixed blade to cut the medium and that cuts the medium on which the image is formed by the printing portion; a discharge guide surface that receives a cut piece of the medium, which is cut by the cutting portion; and a contact portion that is disposed downstream of the movable blade in a discharge direction of the medium and comes into contact with a surface of the medium on a side close to the fixed blade when the cutting portion cuts the medium.

Accordingly, the cut piece of the medium, which is pressed by the movable blade when the medium is cut, can be deformed with the contact portion as a starting point, and a downstream force in the discharge direction can be applied to the cut piece by a reaction force to the deformation. For this reason, stop of the cut piece on the discharge guide surface can be suppressed, and work efficiency for the user can be easily improved.

### Supplementary note 2

The printing apparatus according to supplementary note 1, in which a dimension of the contact portion in a width direction intersecting the discharge direction is larger than a dimension of the medium in the width direction.

Accordingly, since the entire medium in the width direction is easily brought into contact with the contact portion, and the cut piece of the medium, which is pressed by the movable blade, is easily deformed, a downstream force in the discharge direction is easily applied to the cut piece. For this reason, stop of the cut piece on the discharge guide surface can be suppressed, and work efficiency for the user can be easily improved.

### Supplementary note 3

The printing apparatus according to supplementary note 1 or 2, in which when the cutting portion cuts the medium, the movable blade moves from one side to another side in an up/down direction, and a tip of the contact portion on the one side in the up/down direction is positioned on the one side in the up/down direction of a tip of the movable blade, which is moved to the other side when the medium is cut.

Accordingly, when the cut piece of the medium is pressed to the other side in the up/down direction by the movable blade, the surface of the cut piece on the side close to the fixed blade is easily brought into contact with the contact portion, and the cut piece can be easily deformed. For this reason, stop of the cut piece on the discharge guide surface can be suppressed, and work efficiency for the user can be easily improved.

### Supplementary note 4

The printing apparatus according to supplementary note 1 or 2, in which when the cutting portion cuts the medium, the movable blade moves from one side to another side in an up/down direction, and a tip of the contact portion on the one side in the up/down direction is positioned on the other side in the up/down direction of a tip of the fixed blade on the one side in the up/down direction.

Accordingly, when the medium is transported downstream in the discharge direction, collision between the contact portion and the tip of the medium, which is downstream in the discharge direction can be suppressed.

### Supplementary note 5

The printing apparatus according to supplementary note 3, in which the tip of the contact portion on the one side in the up/down direction is positioned on the other side in the up/down direction of a tip of the fixed blade on the one side in the up/down direction.

Accordingly, when the medium is transported downstream in the discharge direction, collision between the contact portion and the tip of the medium, which is downstream in the discharge direction can be suppressed.

### Supplementary note 6

The printing apparatus according to any one of supplementary notes 1 to 5, in which the discharge guide surface is inclined by 30° or more in a direction in which a downstream portion in the discharge direction is positioned on a lower side with a horizontal plane as reference.

Accordingly, the cut piece that falls onto the discharge guide surface easily slides on the discharge guide surface downstream in the discharge direction due to the action of gravity. For this reason, stop of the cut piece on the discharge guide surface can be suppressed, and work efficiency for the user can be easily improved.

### Supplementary note 7

The printing apparatus according to any one of supplementary notes 1 to 6, in which the contact portion is provided upstream of a movable width direction guide, which is provided on the discharge guide surface, in the discharge direction.

Accordingly, the contact portion can be disposed close to the cutting portion, and the cut piece and the contact portion can be brought into contact with each other, for example, even when the cut length of the cut piece is short or the like. For this reason, stop of the cut piece on the discharge guide surface can be suppressed, and work efficiency for the user can be easily improved.

### Supplementary note 8

The printing apparatus according to any one of supplementary notes 1 to 7, further including: a discharge guide member formed with the discharge guide surface, in which the contact portion is provided in the discharge guide member.

Accordingly, the configurations of the contact portion and the discharge guide surface can be simplified.

### Supplementary note 9

The printing apparatus according to any one of supplementary notes 1 to 7, further including: a contact member that has a pair of support portions and the contact portion supported by the pair of support portions.

Accordingly, the contact portion and the discharge guide surface can be made of separate members, and a degree of freedom in design can be easily ensured.

### Supplementary note 10

The printing apparatus according to supplementary note 9, in which the support portions are movable along the discharge direction.

Accordingly, a position where the contact portion comes into contact with the cut piece of the medium can be adjusted according to the type of the medium or the cut length of the cut piece, and a force can be easily applied to the cut piece downstream in the discharge direction. For this reason, stop of the cut piece on the discharge guide surface can be suppressed, and work efficiency for the user can be easily improved.

### Supplementary note 11

The printing apparatus according to supplementary note 10, further including: a drive portion that moves the pair of support portions along the discharge direction; and a control portion that operates the drive portion and moves the pair of support portions according to a cut length of the cut piece.

Accordingly, a position where the contact portion comes into contact with the cut piece of the medium can be automatically adjusted according to the type of the medium or the cut length of the cut piece, and a force can be easily applied to the cut piece downstream in the discharge direction. For this reason, stop of the cut piece on the discharge guide surface can be suppressed, and work efficiency for the user can be easily improved.

What is claimed is:

1. A printing apparatus comprising:
a transport portion that transports a medium;
a printing portion that forms an image on the medium;
a cutting portion that has a fixed blade and a movable blade which moves up/down with respect to the fixed blade to cut the medium and that cuts the medium on which the image is formed by the printing portion;
a discharge guide surface that receives a cut piece of the medium, which is cut by the cutting portion; and
a contact portion that is disposed downstream of the movable blade in a discharge direction of the medium and comes into contact with a surface of the medium on a side close to the fixed blade when the cutting portion cuts the medium.

2. The printing apparatus according to claim 1, wherein
a dimension of the contact portion in a width direction intersecting the discharge direction is larger than a dimension of the medium in the width direction.

3. The printing apparatus according to claim 1, wherein
when the cutting portion cuts the medium, the movable blade moves from one side to another side in an up/down direction, and
a tip of the contact portion on the one side in the up/down direction is positioned on the one side in the up/down direction of a tip of the movable blade, which is moved to the other side when the medium is cut.

4. The printing apparatus according to claim 1, wherein
when the cutting portion cuts the medium, the movable blade moves from one side to another side in an up/down direction, and
a tip of the contact portion on the one side in the up/down direction is positioned on the other side in the up/down direction of a tip of the fixed blade on the one side in the up/down direction.

5. The printing apparatus according to claim 3, wherein
the tip of the contact portion on the one side in the up/down direction is positioned on the other side in the up/down direction of a tip of the fixed blade on the one side in the up/down direction.

6. The printing apparatus according to claim 1, wherein
the discharge guide surface is inclined by 30° or more in a direction in which a downstream portion in the discharge direction is positioned on a lower side with a horizontal plane as reference.

7. The printing apparatus according to claim 1, wherein
the contact portion is provided upstream of a movable width direction guide, which is provided on the discharge guide surface, in the discharge direction.

8. The printing apparatus according to claim 1, further comprising:
a discharge guide member formed with the discharge guide surface, wherein
the contact portion is provided in the discharge guide member.

9. The printing apparatus according to claim 1, further comprising:
a contact member that has a pair of support portions and the contact portion supported by the pair of support portions.

10. The printing apparatus according to claim 9, wherein
the support portions are movable along the discharge direction.

11. The printing apparatus according to claim 10, further comprising:
a drive portion that moves the pair of support portions along the discharge direction; and
a control portion that operates the drive portion and moves the pair of support portions according to a cut length of the cut piece.
